(19) United States
(12) Patent Application Publication
(10) Pub. No.: US 2009/0293330 A1
(43) Pub. Date: Dec. 3, 2009

(54) Fan-Express

(76) Inventors: Charles Vincent Curley, Wayne, PA (US); Ethan Nahum Halberstadt, Wayne, PA (US)

Correspondence Address: Ethan Halberstadt;Halberstadt Curley, LLC, Suite 425, 1100 E. Hector, St., Conshohocken, PA, 19428, US

(21) Appl. No.: 12/156,210

(22) Filed: May 30, 2008

(51) Int. Cl. G09F 21/04

(52) U.S. Cl. 40/593

(57) ABSTRACT

An article of manufacture (there is no known previous technology) for use in marketing, advertising, and promotion, known as the “Fan-Express” for displaying a driver's support and/or affiliation with a sports team, university, private club, business, religious institution, political party or candidate, or displaying any message on electronic toll collection devices that are mounted on the windshields of motor vehicles that is uniquely designed so that it requires no glue, adhesive, or similar substance to afix to the electronic toll collection device.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of advertising, marketing, and promotion and more specifically to an article of manufacture known as the “Fan-Express” for displaying a driver's support and/or affiliation with a sports team, university, private club, business, religious institution, political party or candidate, or displaying or promoting any message on the driver's electronic toll collection device.

There is no known “previous technology” as it relates to the Fan-Express. Electronic toll collection devises were first implemented in the United States in 1993 through the E-ZPass Intragency Group, which holds U.S. Pat. Nos. 4,870,419; 4,937,581; 5,164,732; 5,192,954; and 5,196,846 and Canada Patent Nos 1,165,427 and 1,248,613. Although there are manufacturers who have produced devices to hold or protect the electronic toll collection devices on the windshield of the automobile, truck, or other vehicle in which it is installed, there is no article of manufacture that has been created which allows drivers to use their electronic toll collection device as the backdrop for displaying the driver's support and/or affiliation with a sports team, university, private club, business, religious institution, political party or candidate, or for displaying any other message.

The only relevant previous technology that is “relevant” to the invention that is the subject of this patent is the underlying technology that operates electronic toll collection devices. The current invention does not impact the underlying technology of electronic toll collection devices. Rather, it allows users of electronic toll collection devices to utilize their electronic toll collection devises as a backdrop for displaying the driver's support and/or affiliation with a sports team, university, private club, business, religious institution, political party or candidate, or displaying any other message consistent with applicable intellectual property laws.

Applicants are unaware of any previous technology and, therefore, are unaware of any “deficiency” in the prior technology. Theoretically, one could apply stickers or apply an adhesive on an electronic toll collection device to display a message; however, the new technology permits a driver to display a message—for instance, to promote the driver's favorite sports team or political candidate—without any adhesives, glues, or other similar substances as a result of the unique design of the Fan-Express. This permits the driver to easily and frequently change the message that the driver wishes to display on her electronic toll collection device. For instance, a driver can easily remove and replace his Fan-Express to show support for his favorite local sports team depending upon the time of year: in baseball season the driver's Fan-Express can display support for his local baseball team; in football season the driver can switch to a Fan-Express displaying his favorite football team logo; in basketball season the driver can switch to a Fan-Express displaying his favorite basketball team logo; and if his favorite team wins the Stanley Cup, his Fan-Express can display his team's logo as Stanley Cup champions. All such logos, trademarks, or other copyrighted materials would only be reproduced consistent with appropriate licensing agreements and applicable intellectual property laws.

### BRIEF SUMMARY OF THE INVENTION

The primary object of the invention is to provide drivers who utilize electronic toll collection devices the ability to quickly and easily show their support or affiliation for a sports team, university, private club, business, religious institution, political party or candidate, or display any other message on their electronic toll collection device.

Another object of the invention is that it provides drivers the means to use their front windshields to display messages in a safe and unobtrusive manner (as the Fan-Express is no larger than the electronic toll collection device already mounted to the windshield).

Another object of the invention is the drivers can quickly and easily change the message that they wish to display as the Fan-Express uses no glues, adhesives, or similar substances which make changing products such as decals and bumper stickers difficult and aesthetically unappealing. A driver can change her Fan-Express literally in seconds without any difficulty.

A further object of the invention is the Fan-Express is held into place by virtue of its unique design and the positioning of the electronic toll collection device on the windshield.

A further object of the invention is to provide advertising and marketing firms another means of providing their clients with an avenue for promoting their products and services.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an article of manufacture known as the “Fan-Express” for displaying a driver's support and/or affiliation with a sports team, university, private club, business, religious institution, political party or candidate, or displaying any message on electronic toll collection devices that are mounted on the windshield of automobiles, trucks, or other vehicles. The invention is a vinyl cover (or cover made out of another acceptable material) that is shaped to fit onto electronic toll collection devices without the need for any glue, adhesive, or similar substance to afix the invention to the electronic toll collection device. By virtue of its unique design, the invention is held into place on top of the electronic toll collection device by virtue of the required positioning of the electronic toll collection device on the windshield and the laws of gravity. There is currently no similar device which allows a driver to use her electronic toll collection device as a backdrop for displaying messages to the public.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a plan view of the invention that shows the dimensions of the invention for use on an E-ZPass electronic toll collection device. The dimensions may be altered or configured differently to work with other electronic toll collection devices.

FIG. 2 is a plan view of the invention that shows the unique design which allows the invention to be positioned on an electronic toll collection device without any adhesives, glue, or similar substance.

FIG. 3 is used for illustrative purposes only and is not a patentable part of the invention. Rather, FIG. 3 provides an example of how a driver can display his support for the Philadelphia Phillies (the symbol shown as FIG. 3 is the copyrighted and trademarked design of the Philadelphia Phillies organization) and would not be reproduced as part of the invention absent an appropriate licensing agreement authorizing the inventors to use the copyrighted design.

FIG. 4 is a plan view of the E-Z Pass electronic toll collection device (not a part of the invention but shown for illustrative purposes), showing the the side of the electronic toll collection device which faces the driver and which will not be enhanced with the invention.

FIG. 5 is a plan view of the E-Z Pass electronic toll collection device (not a part of the invention but shown for illustrative purposes), showing the placement of the velcro strips on the electronic toll collection device which allows the unique design of the invention to fit onto the electronic toll collection device without the need for any adhesives, glue, or similar substances. FIG. 5 shows the view of the E-Z Pass electronic toll collection device which faces the windshields and which will hold the invention into place.

FIG. 6 is a plan view of the invention showing the “cut-outs” (in black) which create the unique design which allows the invention to fit onto the electronic toll collection device without the need for adhesives, glue, or similar substances.

FIG. 7 is a plan view of the E-Z Pass electronic toll collection device (with velcro attachments) which is shown in juxtaposition with the invention to show the placement of the invention on the electronic toll collection device.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

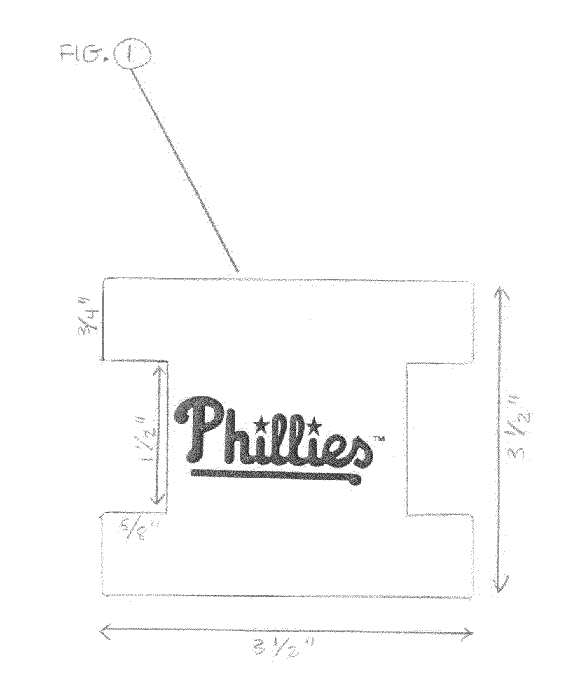

Turning to FIG. 1, the drawing shows the dimensions of the article of manufacture, known as the “Fan-Express,” which will be made out of vinyl or other acceptable substitute material. The dimensions that are illustrated on FIG. 1 are for use on an E-ZPass electronic toll collection device. The dimensions may be altered or configured differently to work with other electronic toll collection devices.

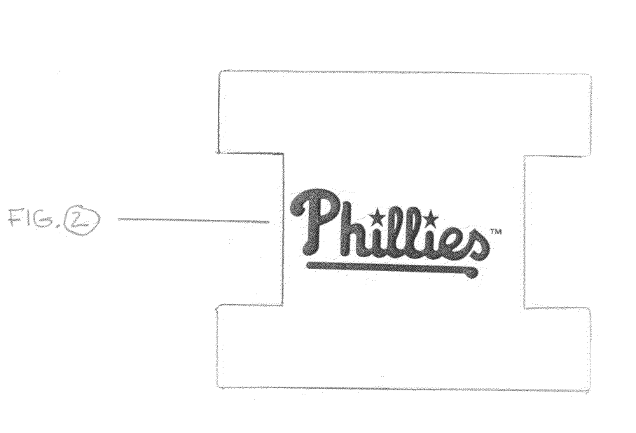

Turning to FIG. 2, the drawing shows the unique design of the invention which allows it to fit securely on the E-Z Pass electronic toll collection device without the need for any adhesives, glue, or similar substances.

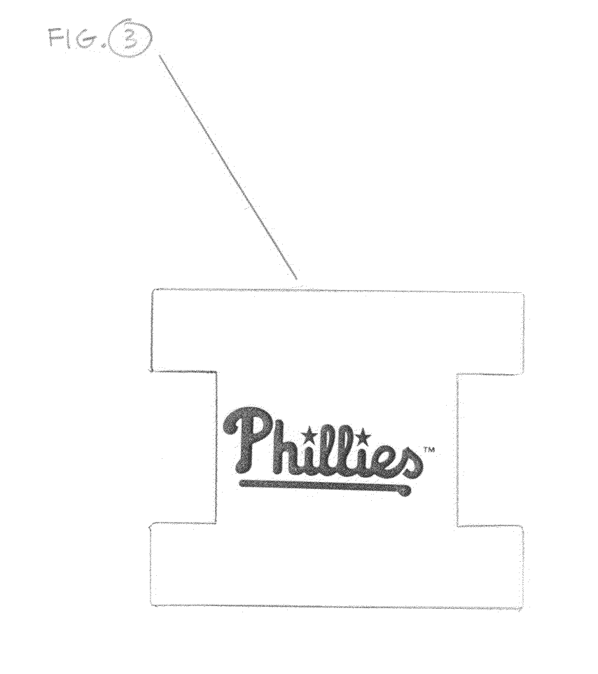

Turning to FIG. 3, the drawing illustrates the use of the invention to promote a professional sports team (the logo of the Philadelphia Phillies shown in FIG. 3 is for illustrative purposes only and is not a part of the invention. The Philadelphia Phillies logo is the copyright of the Philadelphia Phillies organization. FIG. 3 depicts how the invention can be used in order to display a driver's support and/or affiliation with a sports team, university, private club, business, religious institution, political party or candidate, or displaying any message. The use of displays for marketing, advertising, and promotion is already well known in the advertising and marketing industry; however, there is no known invention which allows an electronic toll collection device to be used for marketing, advertising, and promotion.

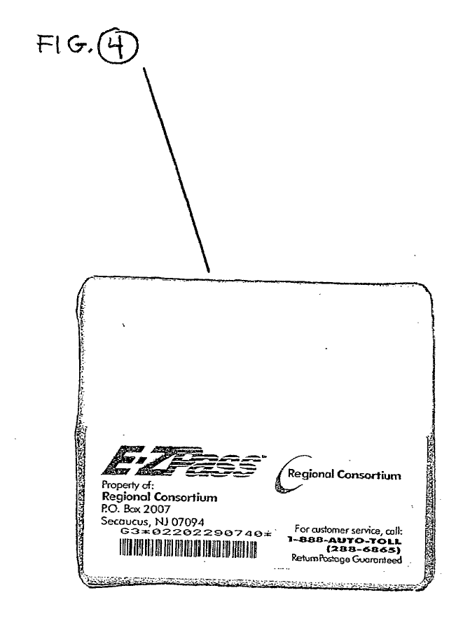

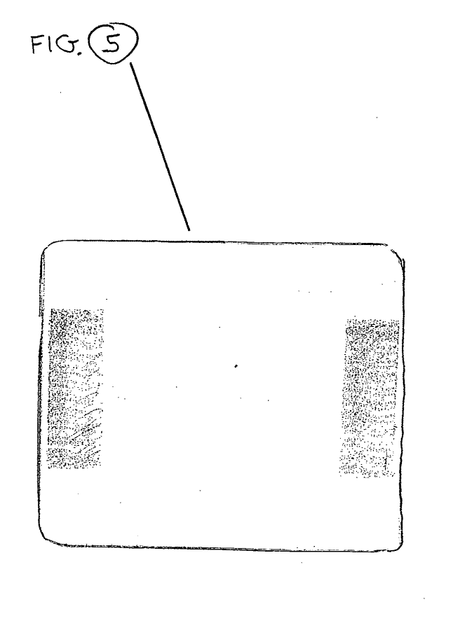

Turning to FIG. 4, the drawing depicts the E-Z Pass electronic toll collection device upon which the invention will be affixed. FIG. 4 shows the side of the electronic toll collection device that faces the driver to which the invention will not be affixed. Turning to FIG. 5, the drawing depicts the E-Z Pass electronic toll collection device, and the position of the velcro strips which allow the device to be fastened to the windshield of the automobile or other vehicle, which faces the windshield of the automobile or other vehicle using the device. The invention will be affixed to this side of the electronic toll collection device by fitting securely around the velcro strips and staying in place by virtue of the positioning of the device on the windshield and the laws of gravity. No adhesives, glue, or similar substances to affix the invention to the electronic toll collection device.

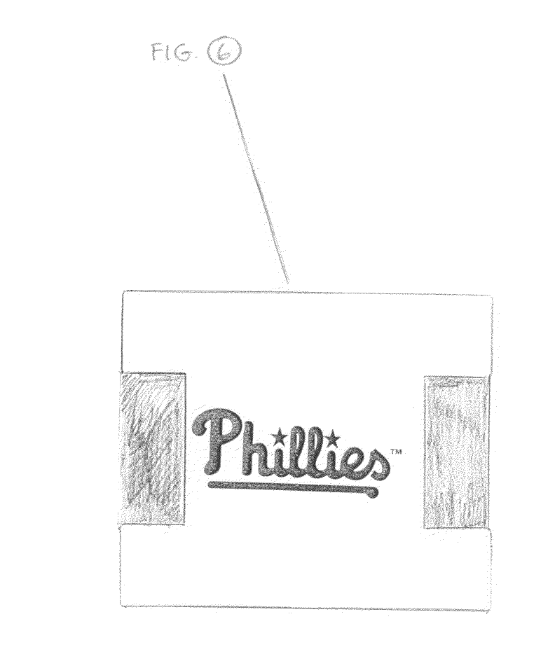

Turning to FIG. 6, the drawing highlights the unique shape of the invention and, in particular, the “cut-outs” (in black) which allows the invention to fit securely around the velcro tape located on the electronic toll collection device.

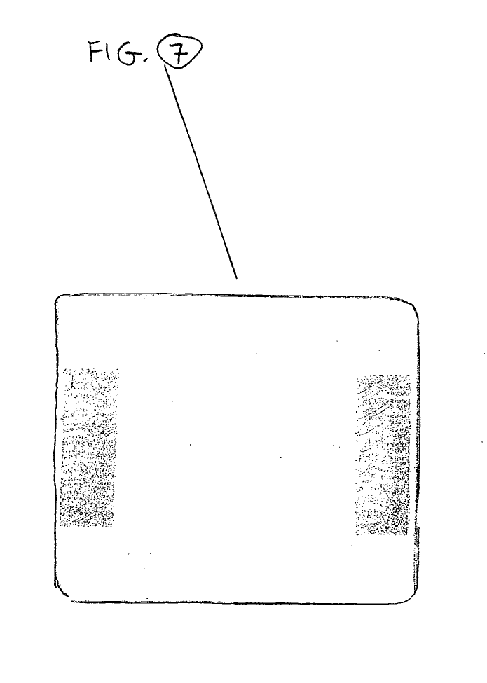

Turning to FIG. 7, the drawing shows the side of electronic toll device upon which the invention will be affixed and, in particular, the relative positioning of the velcro strips with the “cut-outs” (depicted in black) shown in FIG. 6. The invention can be re-configured according to the placement of the velcro strips on the electronic toll collection device or any reconfiguration of the electronic toll collection device.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. In combination with the use of electronic toll collection devices, an article of manufacture in the field of advertising, marketing, and promotion known as the “Fan-Express” for displaying a driver's support and/or affiliation with a sports team, university, private club, business, religious institution, political party or candidate, or displaying any message on electronic toll collection devices that are mounted on the windshield of automobiles, trucks, or other vehicles.
1) the invention is made of vinyl or other suitable material pursuant to the dimensions shown on the drawings that is shaped to fit securely on electronic toll collection devices. The dimensions of the invention may be amended or reconfigured so that the invention securely adheres to any electronic toll collection device.
2) the invention requires no glue, adhesive, or similar substance to afix to the electronic toll collection device.
3) by virtue of its unique design, the invention is held into place on top of the electronic toll collection device by virtue of the required positioning of the electronic toll collection device underneath the windshield of the vehicle, the placement of the velcro strips used on the device to hold it into place on the electronic toll collection device, and the laws of gravity;
4) there is currently no similar article of manufacture which allows a driver to use an electronic toll collection device as a backdrop for displaying a message or other promotional use.
